(19) United States
(12) Patent Application Publication
(10) Pub. No.: US 2008/0218637 A1
(43) Pub. Date: Sep. 11, 2008

(54) RECEIVING APPARATUS, METHOD OF CONTROLLING APPARATUS, AND PROGRAM FOR IMPLEMENTING THE METHOD

(75) Inventors: Hiroyoshi Hayashi, Saitama (JP); Tsuyoshi Sakuma, Tokyo (JP); Koki Tsukahara, Saitama (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/041,925

(22) Filed: Mar. 4, 2008

(30) Foreign Application Priority Data
Mar. 5, 2007 (JP) 2007-053638

(51) Int. Cl. H04N 5/14; H04N 9/64; H04N 5/455

(52) U.S. Cl. 348/707; 348/721; 348/726; 348/E05.062; 348/E09.037; 348/E05.113

(57) ABSTRACT

A receiving apparatus for receiving a digital television broadcast includes an amplification unit that amplifies radio frequency signals supplied from an antenna at a predetermined gain to output the amplified radio frequency signals, a channel selection unit that selects a broadcast wave from the radio frequency signals output from the amplification unit to produce output signals, a demodulation unit that processes the output signals to demodulate content data transmitted on the broadcast wave, and a control unit that controls the gain of the amplification unit so that the signal level of the output signals becomes a predetermined value. The control unit controls the gain of the amplification unit using the control start value and changes the control start value in accordance with the result of processing by the demodulation unit.

### CROSS REFERENCES TO RELATED APPLICATIONS

The present invention contains subject matter related to Japanese Patent Application JP 2007-053638 filed in the Japanese Patent Office on Mar. 5, 2007, the entire contents of which are incorporated herein by reference.

### BACKGROUND OF THE INVENTION

1. Field of the Invention

The present invention relates to a receiving apparatus, a method of controlling the receiving apparatus, and a program for implementing the method. The present invention is applicable to a portable receiver capable of receiving, for example, digital terrestrial broadcasts. The present invention intends to change a control start value, at which automatic gain control is started in accordance with an increase in input signal level, in response to deterioration of a receiving state to prevent an increase in power consumption and stably receive a desired wave even in the presence of an interference wave of high electric field strength.

2. Description of the Related Art

Related-art tuners for television broadcasting each control the gain of an input stage by feedback control using an automatic gain control (AGC) circuit so that the level of a signal transmitted on a broadcast wave (hereinafter, the signal level of a broadcast wave) selected by a channel selection unit becomes a predetermined value. When the gain is insufficient by gain control through the AGC circuit, a radio frequency amplifier (hereinafter, RF amp) is provided for the input stage so that the RF amp amplifies a broadcast wave supplied from an antenna.

As for this type of automatic gain control, for example, Japanese Unexamined Patent Application Publication No. 2001-244836 discloses a method of reducing a control target value of automatic gain control during channel selection to stably perform a channel selecting operation.

In some cases, an antenna receives a desired wave, serving as a broadcast wave in a selected channel, and an interference wave caused by another broadcast wave and the signal level of the interference wave is higher than that of the desired wave in the input stage of a related-art tuner, as shown in FIG. 10A. In this instance, when gain control is performed so that the signal level of the desired wave in the selected channel becomes a constant value, the amplitude of the interference wave enters a nonlinear region in the input stage, as shown in FIG. 10B. Disadvantageously, the interference wave becomes distorted. The distortion of the interference wave causes spurious signals. The spurious signals are generated in a frequency band of the desired wave, thus reducing the C/N ratio of the desired wave. Unfortunately, it is difficult for the related-art tuner to receive the desired wave normally. In FIGS. 10A and 10B, “IN” indicates various broadcast waves supplied to the tuner and “OUT” indicates various broadcast waves amplified in the input stage.

According to one approach to solving the above-described problems, the linear region of the tuner is sufficiently increased to prevent the distortion of the interference wave. However, this approach has a disadvantage in that the power consumption of the tuner increases.

### SUMMARY OF THE INVENTION

The present invention is made in consideration of the above-described problems and it is desirable to provide a receiving apparatus capable of stably receiving a desired wave even in the presence of an interference wave of high electric field strength while preventing an increase in power consumption, a method of controlling the receiving apparatus, and a program for implementing the method.

According to an embodiment of the present invention, a receiving apparatus for receiving a digital television broadcast includes the following elements. An amplification unit amplifies radio frequency signals supplied from an antenna at a predetermined gain to output the amplified radio frequency signals. A channel selection unit selects a broadcast wave from the radio frequency signals output from the amplification unit to produce output signals. A demodulation unit processes the output signals to demodulate content data transmitted on the broadcast wave. A control unit controls the gain of the amplification unit so that the signal level of the output signals becomes a predetermined value. The control unit controls the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value. The control unit changes the control start value in accordance with the result of processing by the demodulation unit.

According to another embodiment of the present invention, there is provided a method of controlling a receiving apparatus for receiving a digital television broadcast, the apparatus including an amplification unit that amplifies radio frequency signals supplied from an antenna at a predetermined gain to output the amplified radio frequency signals, a channel selection unit that selects a broadcast wave from the radio frequency signals output from the amplification unit to produce output signals, and a demodulation unit that processes the output signals to demodulate content data transmitted on the broadcast wave. The method includes the steps of controlling the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value, and changing the control start value in accordance with the result of processing by the demodulation unit.

According to another embodiment of the present invention, there is provided a program for implementing a method of controlling a receiving apparatus that receives a digital television broadcast, the apparatus including an amplification unit that amplifies radio frequency signals supplied from an antenna at a predetermined gain to output the amplified high frequency signals, a channel selection unit that selects a broadcast wave from the radio frequency signals output from the amplification unit to produce output signals, and a demodulation unit that processes the output signals to demodulate content data transmitted on the broadcast wave. The program for implementing the method includes the step of, in gain control for controlling the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value, changing the control start value in accordance with the result of processing by the demodulation unit.

According to the above-described embodiments, when data is not normally demodulated due to deterioration of, for example, the C/N ratio, the control start value for automatic gain control is changed, so that data can be demodulated normally. Consequently, an increase in power consumption is prevented and a desired wave can be received stably even in the presence of an interference wave of high electric field strength.

According to the present invention, advantageously, an increase in power consumption is prevented and a desired wave can be stably received even in the presence of an interference wave of high electric field strength.

### BRIEF DESCRIPTION OF THE DRAWINGS

FIG. 1 is flowchart of a process performed by a control unit in a receiver according to a first embodiment of the present invention;

FIG. 2 is a block diagram illustrating a digital terrestrial broadcasting system according to the first embodiment of the present invention;

FIG. 3 is a diagram explaining a transport stream in the digital terrestrial broadcasting system shown of FIG. 2;

FIG. 4 is a block diagram illustrating the structure of a tuner in the receiver in the digital terrestrial broadcasting system of FIG. 2;

FIGS. 5A and 5B are signal waveform charts explaining operations in the tuner of FIG. 4;

FIGS. 6A and 6B are signal waveform charts explaining the operations in the tuner;

FIG. 7 is a flowchart of a process performed by a control unit in a receiver according to a second embodiment of the present invention;

FIG. 8 is a flowchart of a process performed by a control unit in a receiver according to a third embodiment of the present invention;

FIG. 9 is a flowchart of a process performed by a control unit in a receiver according to a fourth embodiment of the present invention; and

FIGS. 10A and 10B are signal waveform charts explaining the deterioration of the C/N ratio of a desired wave in the presence of an interference wave.

### DESCRIPTION OF THE PREFERRED EMBODIMENTS

Embodiments of the present invention will be described in detail below with reference to the drawings.

### First Embodiment

### (1) Structure of First Embodiment

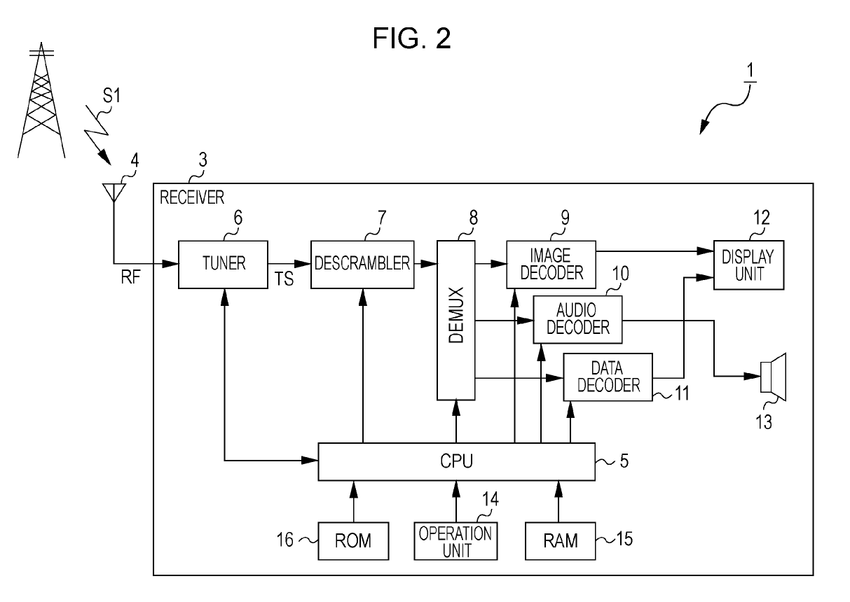

FIG. 2 is a block diagram illustrating a digital terrestrial broadcasting system according to a first embodiment of the present invention. The digital terrestrial broadcasting system, indicated at 1, receives a broadcast wave transmitted from a broadcasting station 2 through a receiver 3 and provides various pieces of video content to a user.

The broadcasting station 2 performs encoding on video data and audio data, serving as data sets constituting video content, in accordance with, for example, MPEG-2 (Moving Picture Experts Group 2) standard and performs time division multiplexing on the encoded data sets, thus generating a transport stream (TS) of MPEG-2 Systems.

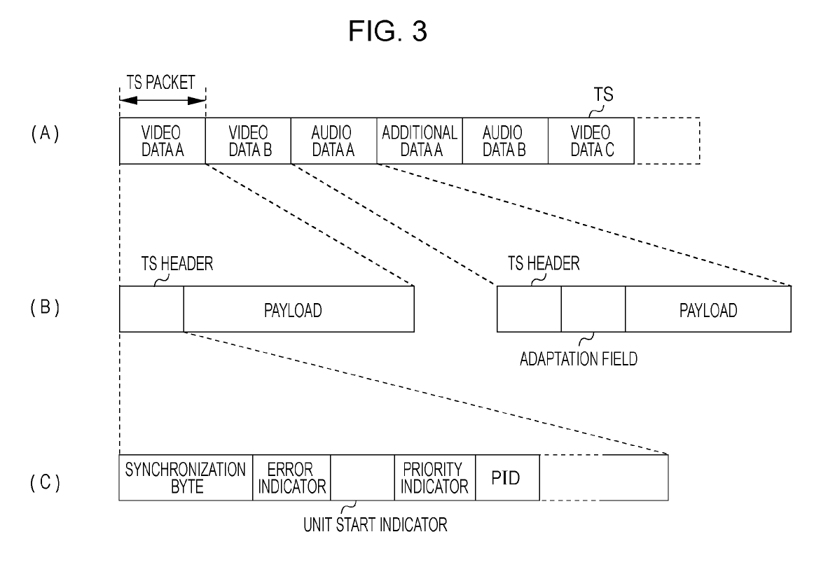

Referring to part (A) in FIG. 3, the transport stream (TS) includes a series of transport stream packets (TS packets). Those packets include a video packet to which video data is assigned, an audio packet to which audio data is assigned, and an additional packet to which additional data is assigned. The additional data includes, for example, text broadcasting data.

Each packet has a fixed length of 188 bytes. Referring to part (B) in FIG. 3, each packet contains a header and a payload. An adaptation field may be disposed next to the header. The adaptation field may store information indicating the kind of data in the payload following the adaptation field.

Referring to part (C) in FIG. 3, each header contains a synchronization byte for detecting the head of the packet, an error indicator indicating the presence or absence of a bit error in the packet, a unit start indicator indicating the start of a new packetized elementary stream (PES) packet, a priority indicator indicating the level of importance of the packet, and a packet identification (PID) indicating the attribute of the packet in that order. The PID contains thirteen bits and is used as a packet selection reference in the receiver 3, which will be described later.

The broadcasting station 2 (refer to FIG. 2) scrambles the transport stream TS and modulates the resultant stream in accordance with the orthogonal frequency division multiplex (OFDM) modulation method for producing a signal resistant to multipath interference, thus generating the modulated signals. The broadcasting station 2 transmits the modulated signals on a broadcast wave S1 having a predetermined frequency.

The receiver 3 is, for example, a portable receiver. The receiver 3 receives a broadcast wave sent from the broadcasting station 2 and provides various pieces of video content to the user.

Specifically, in the receiver 3, an antenna 4 receives various radio frequency signals RF and supplies the signals to a tuner 6. The tuner 6 selects the broadcast wave S1 under the control of a central processing unit (CPU) 5. The tuner 6 demodulates the transport stream TS obtained from the selected broadcast wave and outputs the resultant stream.

A descrambler 7 descrambles the transport stream TS supplied from the tuner 6 and outputs the resultant stream. A demultiplexer (DEMUX) 8 receives the transport stream TS from the descrambler 7, separates the stream into packets on the basis of the PIDs contained in the respective packets, and selectively outputs video data, audio data, and additional data assigned to the packets to an image decoder 9, an audio decoder 10, and a data decoder 11, respectively.

When receiving the image data from the demultiplexer 8, the image decoder 9 decodes the received data and outputs the decoded data. When receiving the audio data from the demultiplexer 8, the audio decoder 10 decodes the received data and outputs the decoded data. When receiving the additional data from the demultiplexer 8, the data decoder 11 decodes the received data and outputs the decoded data. A display unit 12 displays the video data output from the image decoder 9 and also displays text information based on the additional data output from the data decoder 11 in an “on screen display (OSD)” manner under the control of the CPU 5. An audio output unit 13 drives a speaker in accordance with the audio data output from the audio decoder 10 and provides sounds based on the audio data to the user.

An operation unit 14 includes various controls for receiving a user operation and a remote commander and notifies the CPU 5 of various user operations.

The CPU 5 serves as a main controller for controlling an operation of the receiver 3. The CPU 5 reserves a working area in a random access memory (RAM) 15 and executes a program stored in a read-only memory (ROM) 16 to control respective units in accordance with a user operation.

When the user gives an instruction to receive a program broadcasted on the broadcast wave S1, the CPU 5 controls the tuner 6 to select the broadcast wave S1, further controls the image decoder 9, the audio decoder 10, and the data decoder 11 to process an obtained transport stream transmitted on the broadcast wave S1, and provides video content obtained via the broadcast wave S1 to the user.

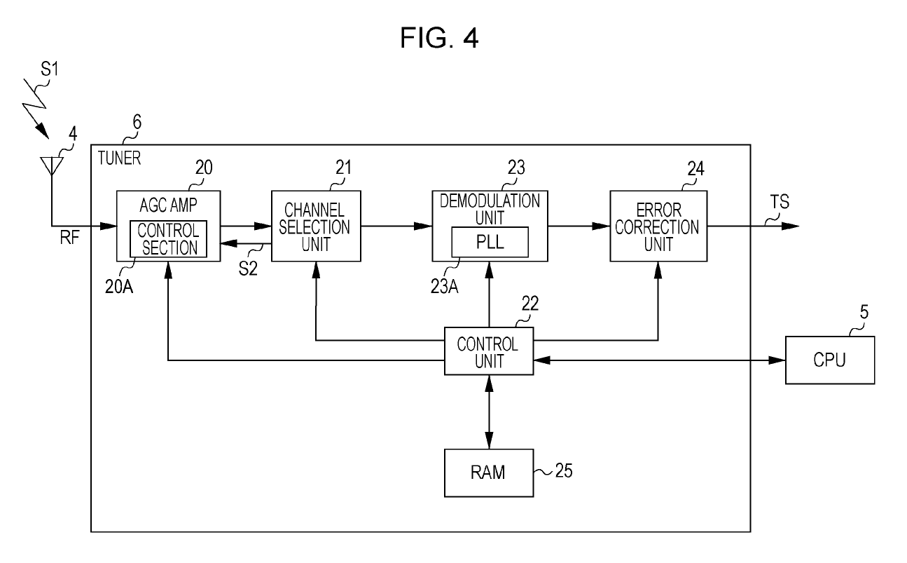

FIG. 4 is a block diagram illustrating the detailed structure of the tuner 6. In the tuner 6, an AGC amplifier (hereinafter, AGC amp) 20, serving as a wideband amplifying circuit, amplifies the radio frequency signals RF supplied from the antenna 4 at a predetermined gain and outputs the resultant signals. The AGC amp 20 receives a detected signal level S2 of the broadcast wave S1 and a control start value for automatic gain control from a channel selection unit 21 and a control unit 22, respectively. A control section 20A included in the AGC amp 20 changes the gain for amplifying the radio frequency signals RF so that the detected signal level S2 becomes a control target value corresponding to the control start value.

When the signal level of a desired wave included in the radio frequency signals RF is lower than the control start value, the AGC amp 20 amplifies the radio frequency signals RF at a maximum gain and outputs the resultant signals. When the signal level of the desired wave is higher than the control start value, the AGC amp 20 reduces the gain at a constant rate with increasing the signal level of the desired wave as compared to the control start value. Consequently, the AGC amp 20 performs automatic gain control on the basis of the detected signal level S2, the maximum gain, indicated at Gmax, and the control start value, indicated at AP.

The channel selection unit 21 generates a local oscillation signal through a local oscillator in accordance with an instruction from the control unit 22 and converts the radio frequency signals RF output from the AGC amp 20 into intermediate frequency signals using the local oscillation signal. The channel selection unit 21 limits the bandwidth of the intermediate frequency signals. After that, the channel selection unit 21 detects the signals to select the broadcast wave S1 specified by the control unit 22 and then demodulates the OFDM-modulated signals. The channel selection unit 21 further detects the signal level of the intermediate frequency signals to detect the signal level of the selected broadcast wave and notifies the AGC amp 20 of the detected signal level S2.

A demodulation unit 23 allows an internal phase locked loop (PLL) circuit 23A to generate clocks on the basis of the modulated signals demodulated through the channel selection unit 21. The demodulation unit 23 further processes the modulated signals using the clocks to demodulate the transport stream TS and then outputs the stream. During the above-described series of processing, the demodulation unit 23 detects the event of loss of synchronization in the PLL circuit 23A and notifies the control unit 22 of the event.

An error correction unit 24 performs error correction on the transport stream TS demodulated through the demodulation unit 23 and outputs the resultant stream to the descrambler 7.

The control unit 22 reserves a working area in a random access memory (RAM) 25 and executes a program recorded in a memory (not shown), thus controlling operations of the respective units. In the present embodiment, as for the program executed by the control unit 22, the program previously installed in the receiver 3 is provided. The program may be installed through a recording medium, such as an optical disk, a magnetic disk, or a memory card. Alternatively, the program may be installed by downloading through a network, such as the Internet. The RAM 25 also functions as a storage area for set values of various registers.

The control unit 22 controls the units as described above and allows the channel selection unit 21 to select the broadcast wave S1 in accordance with an instruction supplied from the CPU 5. In addition, the control unit 22 monitors the receiving state and detects deterioration of the receiving state on the basis of the event of loss of synchronization notified by the demodulation unit 23. On the basis of the detection of the event, the control unit 22 changes the control start value for automatic gain control to be notified to the AGC amp 20. In the following description, the control start value for automatic gain control will be termed “attack point”.

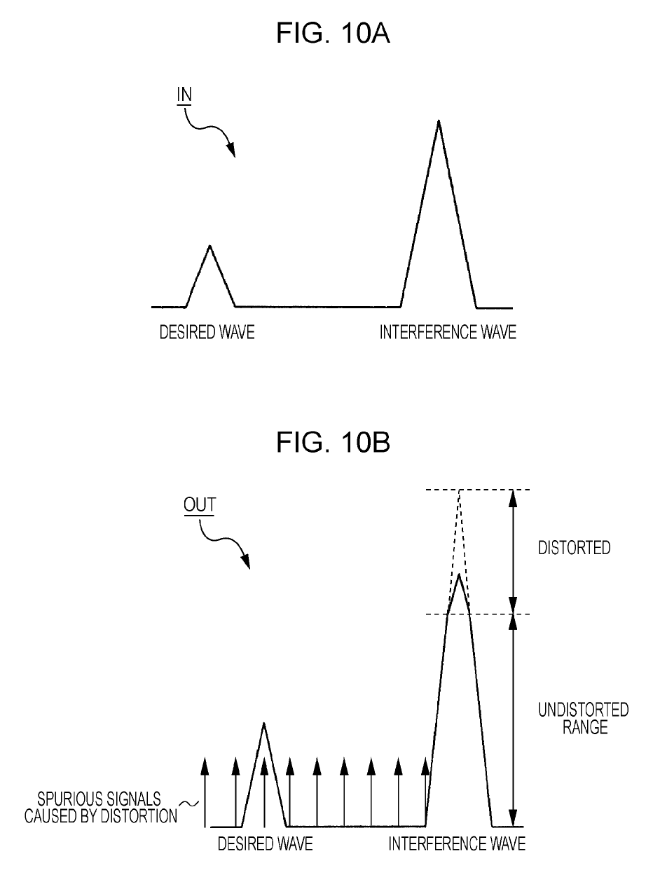

In this case, if the gain of the AGC amp 20 is merely controlled so that the signal level of a broadcast wave detected by the demodulation unit 23 becomes the control target value, the amplitude of an interference wave of high electric field strength enters the nonlinear region in the AGC amp 20 and the channel selection unit 21, as described above with reference to FIGS. 10A and 10B. Disadvantageously, the interference wave becomes distorted, thus resulting in a reduction in the C/N ratio of the desired wave.

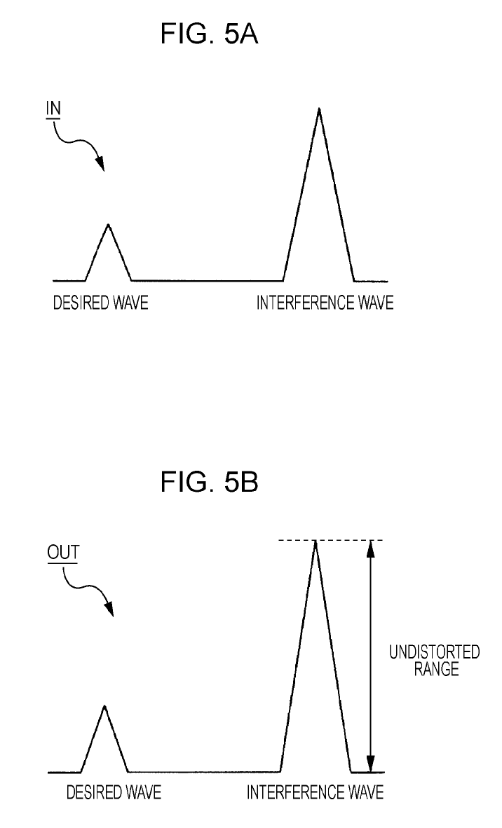

Referring to FIGS. 5A and 5B, when the value of an attack point is reduced, the signal level of the interference wave is reduced, so that the amplitude of the interference wave can be held in the linear region in the AGC amp 20 and the channel selection unit 21, as compared with the case shown in FIGS. 10A and 10B. In this case, therefore, the distortion of the interference wave can be prevented, thus preventing the occurrence of spurious signals. The C/N ratio of the desired wave can be improved as compared with the case where the value of the attack point is increased.

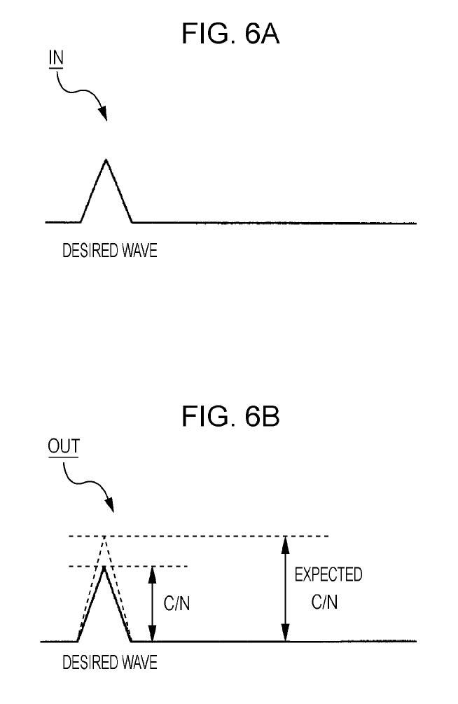

While the attack point is held at a low value as described above, however, if the interference wave is not present as shown in FIGS. 6A and 6B in comparison with FIGS. 10A, 10B, 5A, and 5B, the gain of the desired wave is limited unnecessarily. In other words, although the C/N ratio of the desired wave can be further improved by increasing the signal level of the desired level, the desired wave is kept at a low signal level. Unfortunately, the performance of the receiver is not sufficiently exerted.

In the present embodiment, the receiving state is monitored. When the deterioration of the receiving state is detected on the basis of the event of loss of synchronization notified by the demodulation unit 23, a first attack point AP1 for normal setting is switched to a second attack point AP2 used in the presence of an interference wave, thus controlling the gain of the AGC amp 20. The second attack point AP2 is set lower than the first attack point AP1.

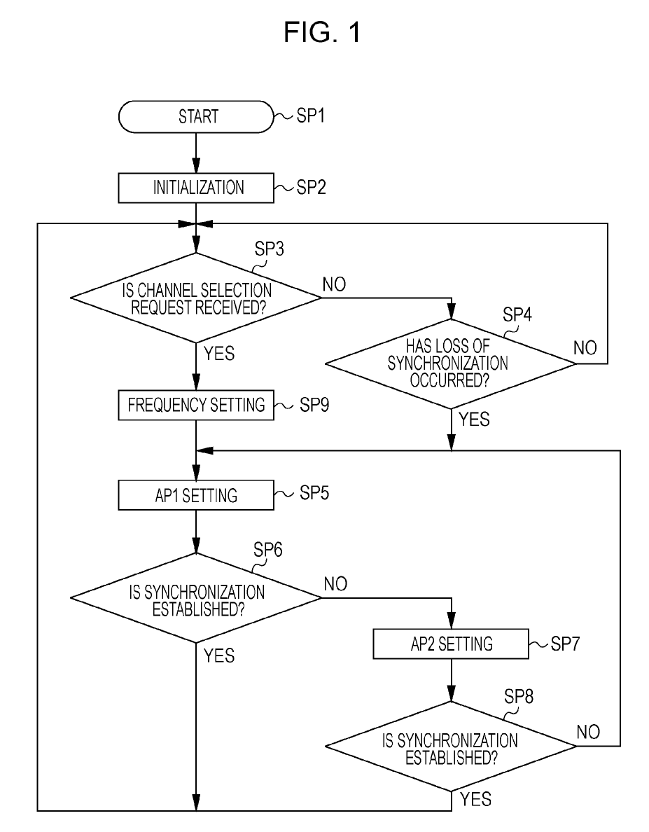

FIG. 1 is a flowchart showing a process for switching between the first and second attack points AP1 and AP2 performed by the control unit 22. When the power is turned on, the control unit 22 starts the process. The process proceeds from step SP1 to step SP2. In step SP2, the control unit 22 performs initialization, i.e., initializes settings of the respective units. During initialization, the control unit 22 selects the first attack point AP1 and notifies the first attack point AP1 to the AGC amp 20. In addition, the control unit 22 allows the channel selection unit 21 to receive a broadcast wave set as a default. As for the default broadcast wave to be received, for example, a broadcast wave which has been recorded as a broadcast wave received just before the preceding power-off through a so-called last memory function.

The process proceeds to step SP3. In step SP3, the control unit 22 determines whether a channel selection request is supplied from the CPU 5. If NO in step SP3, the process proceeds from step SP3 to step SP4. In step SP4, the control unit 22 determines whether loss of synchronization has occurred in the PLL circuit 23A of the demodulation unit 23.

As long as the PLL circuit 23A of the demodulation unit 23 locks on the modulated signals output from the channel selection unit 21 and generates clocks, the control unit 22 determines that loss of synchronization has not occurred. The process is returned to step SP3.

Whereas, if an interference wave of high electric field strength is present, it is difficult to obtain the desired C/N ratio due to the influence of spurious signals generated in the state where the first attack point AP1 is set. Consequently, it is difficult to establish and maintain synchronization in the demodulation unit 23. In this case, wherefore, in step SP4, the control unit 22 determines that loss of synchronization has occurred in the PLL circuit 23A (YES in step SP4).

If YES in step SP4, the process proceeds from step SP4 to step SP5. The control unit 22 again notifies the first attack point AP1 to the AGC amp 20. In step SP6, the control unit 22 determines whether synchronization is established. If NO in step SP6, the process proceeds from step SP6 to step SP7. In step SP7, the control unit 22 notifies the second attack point AP2 to the AGC amp 20, thus switching the first attack point AP1 to the second attack point AP2. In step SP8, the control unit 22 determines whether synchronization is established.

If YES in step SP8, the process is returned to step SP3. If YES in step SP6, the process is similarly returned to step SP3. If NO in step SP8, the process is returned to step SP5. In step SP5, the control unit 22 resets the second attack point AP2 to the first attack point AP1.

Consequently, the control unit 22 selects either the first attack point AP1 or the second attack point AP2 so as to establish and maintain synchronization and controls the gain of the AGC amp 20 on the basis of the selected attack point AP1 or AP2 to receive a default broadcast wave for a period after the power-on until an instruction to select a channel (or channel selection request) is received from the CPU 5.

When the control unit 22 receives the instruction to select a channel from the CPU 5 while receiving the default broadcast wave on the basis of the first attack point AP1 or second attack point AP2, the control unit 22 determines in step SP3 that the channel selection request is received. The process proceeds from step SP 3 to step SP9. In step SP9, the control unit 22 instructs the channel selection unit 21 to select a broadcast wave in accordance with the instruction from the CPU 5. The process proceeds to step SP5.

Consequently, the control unit 22 selects either the first attack point AP1 or the second attack point AP2 so as to establish and maintain synchronization even while receiving the broadcast wave requested by the CPU 5, and controls the gain of the AGC amp 20 on the basis of the selected attack point AP1 or AP2 to receive the broadcast wave.

### (2) Operation of First Embodiment

In the digital terrestrial broadcasting system 1 (see FIG. 2) with the above-described structure, the broadcasting station 2 performs encoding on video data and audio data, serving as data sets constituting video content, in accordance with MPEG-2 standard, performs time division multiplexing on the encoded data sets to generate a transport stream (see FIG. 3), modulates the transport stream in accordance with the OFDM modulation method to generate modulated signals, and transmits the modulated signals on the broadcast wave S1 having the predetermined frequency.

In the receiver 3, the antenna 4 receives various radio frequency signals RF and supplies the signals to the tuner 6. The tuner 6 selects the broadcast wave S1 and demodulates the transport stream TS transmitted on the broadcast wave S1. In the receiver 3, the descrambler 7 descrambles the transport stream TS and the demultiplexer 8 separates the descrambled stream into video data, audio data, and additional data. The image decoder 9 decodes the video data, the audio decoder 10 decodes the audio data, and the data decoder 11 decodes the additional data. In the receiver 3, the decoded video data, the audio data, and the additional data are supplied to the display unit 12 and the audio output unit 13, so that the video content transmitted via the broadcast wave S1 is provided to the user.

In the tuner 6 (refer to FIG. 4) of the receiver 3, the AGC amp 20 receives the various radio frequency signals RF from the antenna 4, amplifies the signals at a predetermined gain, and supplies the resultant signals to the channel selection unit 21. The channel selection unit 21 selects the broadcast wave S1 and demodulates the modulated signals transmitted on the broadcast wave S1. The demodulation unit 23 demodulates the transport stream from the modulated signals. The error correction unit 24 performs error correction on the transport stream and supplies the resultant stream to the descrambler 7.

In the tuner 6, the channel selection unit 21 detects the signal level of the selected broadcast wave S1 and the AGC amp 20 controls the gain so that the detected signal level becomes a control target value corresponding to the control start value notified by the control unit 22.

However, merely controlling the gain of the AGC amp 20 so that the signal level of a received broadcast wave becomes a predetermined value has the following problem: If an interference wave of high electric field strength is present, spurious signals caused by distortion of the interference wave are combined with the desired wave, thus reducing the C/N ratio of the desired wave (see FIGS. 10A and 10B). To prevent the above-described problem, the gain of the AGC amp 20 is reduced by decreasing a control start value, thus improving the C/N ratio of the desired wave (see FIGS. 5A and 5B). However, in the case where the control start value is decreased to reduce the gain of the AGC amp 20, although the C/N ratio of the desired wave can be increased when any interference wave is not present, it is difficult to sufficiently increase the C/N ratio (see FIGS. 6A and 6B). Unfortunately, the performance of the receiver is not exploited.

In the tuner 6 (see FIG. 1) in accordance with the present embodiment, the operation of the PLL circuit 23A in the demodulation unit 23 is monitored to determine whether the receiving state is deteriorated. When the gain of the AGC amp 20 is controlled using the first attack point AP1, serving as a first control start value, upon detecting the deterioration of the receiving state, the control start value is switched from the first attack point AP1 to the second attack point AP2 at which the signal level of the received desired wave is further lowered, thus controlling the gain of the AGC amp 20. Whereas, when the gain of the AGC amp 20 is controlled using the second attack point AP2, serving as a second control start value, upon detecting the deterioration of the receiving state, the control start value is switched from the second attack point AP2 to the first attack point AP1 at which the signal level of the received desired wave is increased, thus controlling the gain of the AGC amp 20.

Consequently, when an interference wave of high electric field strength is present, the gain of the AGC amp 20 is controlled using the second attack point AP2, so that the deterioration of the C/N ratio of the broadcast wave S1 can be prevented. When any interference wave of high electric field strength is not present, the gain of the AGC amp 20 is controlled using the first attack point AP1, so that the C/N ratio of the broadcast wave S1 can be sufficiently increased. Advantageously, a broadcast wave transmitted from a remote place can be received with reliability.

In the present embodiment, since the receiver 3 is of the portable type, the receiving state changes over time due to the movement of the receiver 3. According to the present embodiment, since a control start value for automatic gain control is dynamically changed in accordance with the receiving state, the receiver 3 can receive desired video content with reliability while promptly reacting to various changes in the receiving state.

### (3) Advantages of First Embodiment

With the above-described structure, a control start value for automatic gain control is changed in response to the deterioration of the receiving state, so that a desired wave can be stably received while an increase in power consumption is being prevented even in the presence of an interference wave of high electric field strength.

Since the deterioration of the receiving state is detected on the basis of the loss of synchronization with clocks, the deterioration of the receiving state can be easily detected with reliability, so that the control start value for automatic gain control can be appropriately changed.

### Second Embodiment

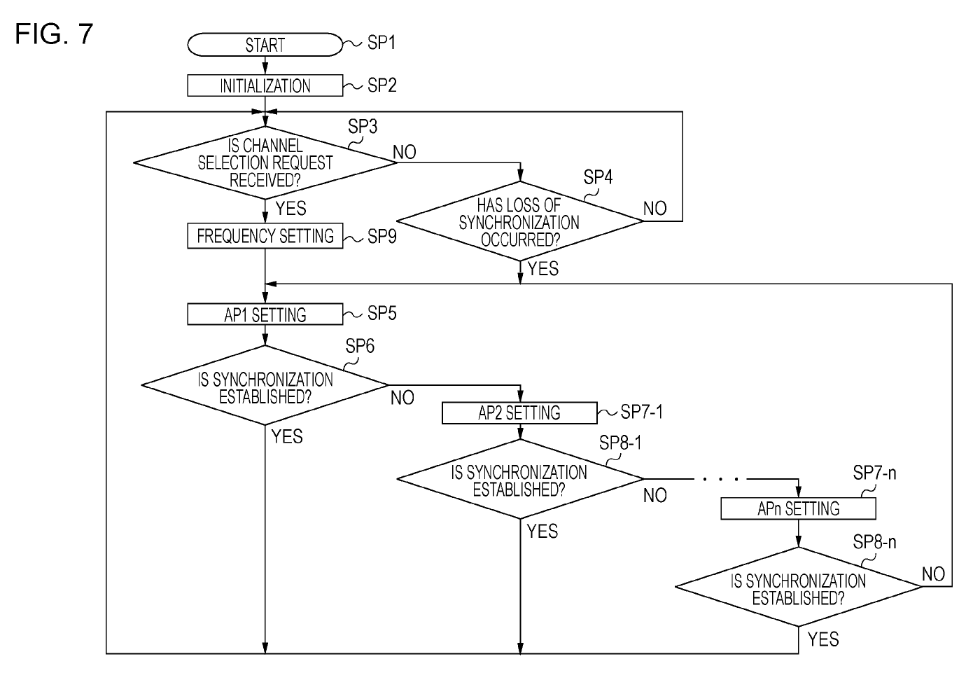

FIG. 7 is a flowchart showing a process by a control unit in a digital terrestrial broadcasting system according to a second embodiment of the present invention. The digital terrestrial broadcasting system according to the second embodiment has the same structure as that according to the first embodiment, except for that the control unit 22 in the tuner 6 performs the process shown in FIG. 7 instead of the process in FIG. 1 to change a control start value for automatic gain control. Accordingly, an explanation will be made using the structures shown in FIGS. 2 and 4. In FIG. 7, the same processing steps as those in FIG. 1 are designated by the same reference numerals.

In the second embodiment, the control unit 22 prepares three or more attack points and switches a control start value between the three or more attack points AP1 to APn in response to the deterioration of the receiving state to perform a process for automatic gain control.

Specifically, when the power is turned on, the control unit 22 starts the process. The process proceeds from step SP1 to step SP 2. In step SP2, the control unit 22 performs initialization and notifies the first attack point AP1 to the AGC amp 20 and further instructs the channel selection unit 21 to receive a broadcast wave set as a default.

In step SP3, the control unit 22 determines whether a channel selection request is supplied from the CPU 5. If NO in step SP3, the process proceeds from step SP3 to step SP4. In step SP4, the control unit 22 determines whether loss of synchronization has occurred in the PLL circuit 23A of the demodulation unit 23. If NO in step SP4, the process is returned to step SP3. If YES in step SP4, the process proceeds from step SP4 to step SP5.

In step SP5, the control unit 22 again notifies the first attack point AP1 to the AGC amp 20. In step SP6, the control unit 22 determines whether synchronization is established. If YES in step SP6, the process is returned from step SP6 to step SP3.

If NO in step SP6, the process proceeds from step SP6 to step SP7-1. The control unit 22 switches the first attack point AP1 to the second attack point AP2. In step SP8-1, the control unit 22 determines whether synchronization is established.

If YES in step SP8-1, the process is returned from step SP8-1 to step SP3. If NO in step SP8-1, the control unit 22 switches the second attack point AP2 to a third attack point AP3 and performs a processing step (hereinafter, referred to as “similar processing step”) similar to that following the foregoing attack-point switching step. If the attack point is sequentially switched to another attack point and synchronization is not established in the use of the last attack point APn, the process is returned from step SP8-n to step SP5. The attack point is reset to the first attack point AP1 and the similar processing step is performed.

According to the present embodiment, since the control start value is switched between three or more control start values in response to the deterioration of the receiving state and automatic gain control is performed using the set control start value, the same advantages as those of the first embodiment can be obtained by coping with the deterioration of the receiving state in a more detailed manner than the first embodiment.

### Third Embodiment

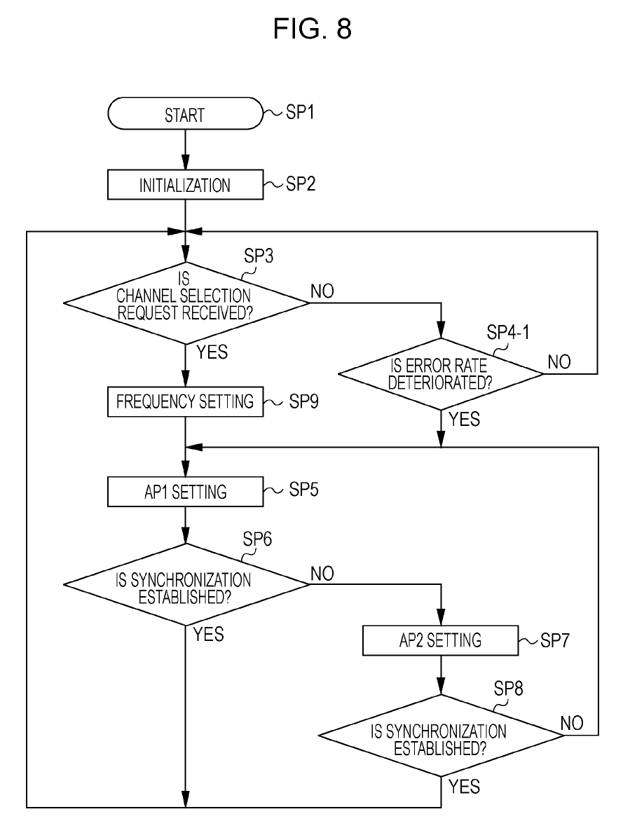

FIG. 8 is a flowchart showing a process performed by a control unit in a digital terrestrial broadcasting system according to a third embodiment of the present invention. The digital terrestrial broadcasting system according to the third embodiment has the same structure as that according to the first embodiment, except for that the control unit 22 in the tuner 6 performs the process shown in FIG. 8 instead of the process in FIG. 1 to change a control start value for automatic gain control. Accordingly, an explanation will be made using the structures shown in FIGS. 2 and 4. In FIG. 8, the same processing steps as those in FIG. 1 are designated by the same reference numerals.

In the third embodiment, when the power is turned on, the control unit 22 starts the process. The process proceeds from step SP1 to step SP2. In step SP2, the control unit 22 performs initialization and notifies the first attack point AP1 to the AGC amp 20 and further instructs the channel selection unit 21 to receive a broadcast wave set as a default.

In step SP3, the control unit 22 determines whether a channel selection request is received from the CPU 5. If NO in step SP3, the process proceeds from step SP3 to step SP4-1. In step SP4-1, the control unit 22 determines whether an error rate is deteriorated to such an extent that it is difficult for the error correction unit 24 to perform error correction. As for the error rate, various error rates, such as the bit error ratio (BER), the packet error ratio (PER), and the error correction rate, are available.

Assuming that synchronization with clocks is lost due to the deterioration of the receiving state, the error rate is significantly deteriorated before the event of loss of synchronization. According to the present embodiment, in step SP4-1, the deterioration of the receiving state is detected on the basis of the deterioration of the error rate instead of the loss of synchronization with the clocks. The deterioration of the receiving state is detected rapidly.

If NO in step SP4-1, the process is returned to step SP3. Whereas, if YES in step SP4-1, the process proceeds to step SP5.

Step SP5 and the subsequent steps or the processing steps performed when the positive determination is obtained in step SP3 are the same as those in the process performed by the control unit 22 in the first embodiment.

According to the present embodiment, the receiving state is monitored on the basis of the error rate in order to determine whether the receiving state is deteriorated and the control start value is changed in response to the deterioration of the error rate. Consequently, the same advantages as those of the first embodiment can be obtained. In addition, since the control start value is changed on the basis of the error rate, the deterioration of the receiving state can be coped with more rapidly than the first embodiment.

### Fourth Embodiment

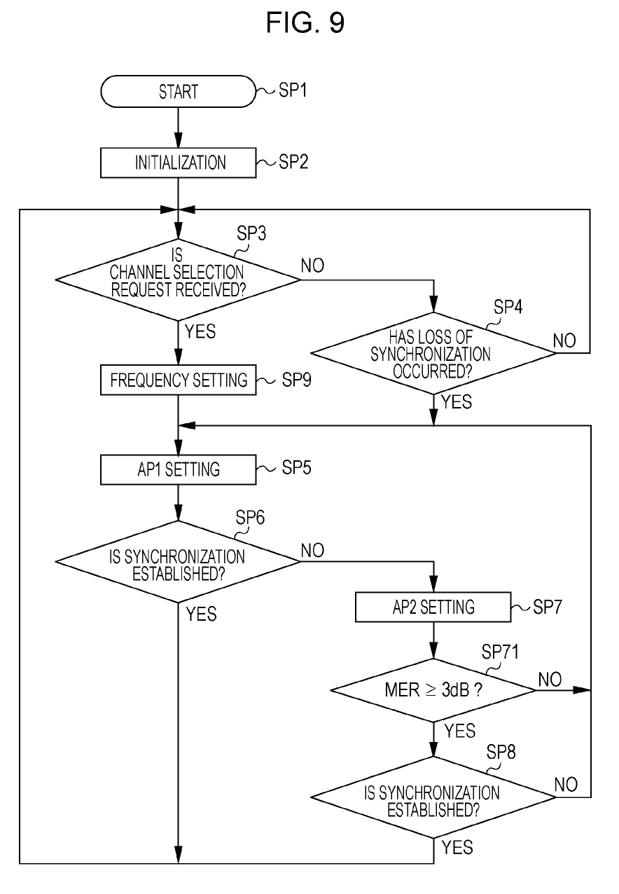

FIG. 9 is a flowchart showing a process by a control unit in a digital terrestrial broadcasting system according to a fourth embodiment of the present invention. The digital terrestrial broadcasting system according to the fourth embodiment has the same structure as that according to the first embodiment, except for that the control unit 22 in the tuner 6 performs the process shown in FIG. 9 instead of the process in FIG. 1 to change a control start value for automatic gain control. Accordingly, an explanation will be made using the structures shown in FIGS. 2 and 4. In FIG. 9, the same processing steps as those in FIG. 1 are designated by the same reference numerals.

In the foregoing embodiments, in some cases, the second attack point AP2 is selected despite the fact that it is effective to select the first attack point AP1 because the electric field strength of a desired wave is low.

According to the fourth embodiment, in step SP7, the control start value is changed to the second attack point AP2, serving as a lower control start value. In step SP71 following step SP7, the control unit 22 determines whether the signal level of the desired wave received through the antenna is at or above a constant value. When the signal level is below the constant value, the control unit 22 switches the second attack point AP2 to the first attack point AP1, serving as a higher control start value. Whereas, if the signal level of the desired wave received through the antenna is at or above the constant value, the control unit 22 determines whether synchronization is established in the use of the second attack point AP2.

In the present embodiment, the signal level of the desired wave received through the antenna is determined using the modulation error ratio (MER). When MER is at or above 3 dB, the control unit 22 resets the control start value to the first attack point AP1, serving as a higher control start value.

According to the present embodiment, only when the signal level of a broadcast wave received through the antenna is below the constant value, the control start value is switched to a lower value. Advantageously, the performance of the receiver in a low electric field strength can be improved, so that the same advantages as those of the first embodiment can be obtained.

### Fifth Embodiment

As has been described in the foregoing third embodiment, the deterioration of the receiving state is detected on the basis of the deterioration of the error rate for a period just after the initialization until a channel selection request is supplied from the CPU. The present invention is not limited to this case. The deterioration of the receiving state may be detected on the basis of the deterioration of the error rate after a desired broadcast wave is selected.

In the above-described embodiments, the deterioration of the receiving state is determined on the basis of the loss of synchronization or the deterioration of the error rate and the control start value is changed in accordance with the determination. The present invention is not limited to the case. The deterioration of the receiving state may be determined on the basis of the loss of synchronization in combination with the deterioration of the error rate or another technique. Alternatively, the deterioration of the receiving state may be determined by another technique.

In the above-described embodiments, the case where the present invention is applied to the mobile receiver has been described. The present invention is not limited to the case. The present invention can be applied to various receivers, such as a vehicle-mounted receiver having functions similar to those of a car navigation system and a receiver incorporated in a mobile phone.

It should be understood by those skilled in the art that various modifications, combinations, sub-combinations and alterations may occur depending on design requirements and other factors insofar as they are within the scope of the appended claims or the equivalents thereof.

What is claimed is:

1. A receiving apparatus for receiving a digital television broadcast, comprising:
an amplification unit that amplifies radio frequency signals supplied from an antenna at a predetermined gain to output the amplified radio frequency signals;
a channel selection unit that selects a broadcast wave from the radio frequency signals output from the amplification unit to produce output signals;
a demodulation unit that processes the output signals to demodulate content data transmitted on the broadcast wave; and
a control unit that controls the gain of the amplification unit so that the signal level of the output signals becomes a predetermined value, wherein
the control unit controls the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value, and
the control unit changes the control start value in accordance with the result of processing by the demodulation unit.

2. The apparatus according to claim 1, wherein
the demodulation unit generates clocks on the basis of the output signals and processes the output signals using the clocks to demodulate the content data, and
the control unit changes the control start value in accordance with the result of processing by the demodulation unit such that the control start value is changed in response to loss of synchronization of the clocks with the output signals.

3. The apparatus according to claim 1, wherein the control unit changes the control start value in accordance with the result of processing by the demodulation unit such that the control start value is changed in response to deterioration of the error rate of the output signals.

4. The apparatus according to claim 1, wherein the control unit changes the control start value so that the signal level of the output signals decreases only when the signal level of the broadcast wave received through the antenna is below a constant value

5. A method of controlling a receiving apparatus for receiving a digital television broadcast,
the apparatus including
an amplification unit that amplifies radio frequency signals supplied from an antenna at a predetermined gain to output the amplified radio frequency signals,
a channel selection unit that selects a broadcast wave from the radio frequency signals output from the amplification unit to produce output signals, and
a demodulation unit that processes the output signals to demodulate content data transmitted on the broadcast wave,
the method comprising the steps of:
controlling the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value; and
changing the control start value in accordance with the result of processing by the demodulation unit.

6. A program for implementing a method of controlling a receiving apparatus that receives a digital television broadcast,
the apparatus including
an amplification unit that amplifies radio frequency signals supplied from an antenna at a predetermined gain to output the amplified high frequency signals,
a channel selection unit that selects a broadcast wave from the radio frequency signals output from the amplification unit to produce output signals, and
a demodulation unit that processes the output signals to demodulate content data transmitted on the broadcast wave,
the program for implementing the method comprising the step of:
in gain control for controlling the gain of the amplification unit such that when the signal level of the broadcast wave included in the radio frequency signals is lower than a control start value, the gain of the amplification unit becomes a constant value, and when the signal level of the broadcast wave included in the radio frequency signals is higher than the control start value, the gain of the amplification unit decreases as the signal level of the broadcast wave increases as compared to the control start value, changing the control start value in accordance with the result of processing by the demodulation unit.
